(19) United States
(12) Patent Application Publication
(10) Pub. No.: US 2012/0311848 A1
(43) Pub. Date: Dec. 13, 2012

(54) SUBSTRATE FRAME SUCTION APPARATUS AND CONTROL METHOD FOR THE SAME

(75) Inventor: Yonmook Park, Suwon-si (KR)

(73) Assignee: SAMSUNG ELECTRONICS CO., LTD., Suwon-si (KR)

(21) Appl. No.: 13/488,777

(22) Filed: Jun. 5, 2012

(30) Foreign Application Priority Data
Jun. 7, 2011 (KR) 10-2011-0054457

(51) Int. Cl. B25B 11/00

(52) U.S. Cl. 29/559; 269/21

(57) ABSTRACT

In one embodiment, a substrate frame suction apparatus includes a body having at least one top-side opened chamber, a suction plate to cover a top of the at least one chamber, and a pressure adjustment device connected to the at least one chamber and configured to adjust a pressure in the at least one chamber.

### CROSS-REFERENCE TO RELATED APPLICATION(S)

This application claims priority under 35 U.S.C. §119 to Korean Patent Application No. 2011-0054457, filed on Jun. 7, 2011 in the Korean Intellectual Property Office (KIPO), entire contents of which are hereby incorporated herein by reference.

### BACKGROUND

1. Field

Embodiments relate to a substrate frame suction apparatus to suction and fix a substrate frame.

2. Description of the Related Art

A substrate frame suction apparatus is used to suction and fix a substrate frame when manufacturing and testing a semiconductor package.

The substrate frame supports a semiconductor attached thereto so as to form a semiconductor package. In order to suction the substrate frame, the substrate frame suction apparatus includes a body having a top-side opened chamber defined therein, a suction plate to cover the opened chamber and provided with a plurality of suction holes, and a pressure adjustment device connected to the chamber to adjust a pressure in the chamber.

Thus, when the chamber reaches a negative pressure state using the pressure adjustment device, the negative pressure (vacuum pressure) is transferred to the substrate frame and, in turn, portions of the substrate frame corresponding to the suction holes are suctioned to the suction plate so that the substrate frame is fixed to the substrate frame suction apparatus. The substrate frame and a semiconductor attached to the frame are tested while the substrate frame is fixed to the substrate frame suction apparatus.

### SUMMARY

At least one embodiment provides a substrate frame suction apparatus capable of suctioning a substrate frame in a stable fashion.

Additional aspects of the embodiments will be set forth in part in the description that follows and, in part, will be obvious from the description, or may be learned by practice of the invention.

In one embodiment, a substrate frame suction apparatus may include a body having at least one top-side opened chamber, a suction plate made of a porous material to cover a top side of the at least one chamber, and a pressure adjustment device connected to the at least one chamber to adjust a pressure in the at least one chamber.

The at least one chamber may include a plurality of chambers defined in the body using partition walls. The pressure adjustment device may be connected to the respective chambers so as to achieve individual pressure adjustments for the plural chambers.

In one embodiment, provided is a method of controlling a substrate frame suction apparatus, the apparatus including a plurality of chambers, a suction plate and a pressure adjustment device to suction a substrate frame. The method may include sequentially bringing the plurality of chambers into a negative pressure state using the pressure adjustment device so that portions of the substrate frame respectively corresponding to a plurality of the chambers are sequentially suctioned to the suction plate.

The sequential bringing of the plurality of chambers into the negative pressure state may occur from a chamber corresponding to one side-end of the substrate frame to a chamber corresponding to the other side-end of the substrate frame in this order.

The sequential bringing of the plurality of chambers into the negative pressure state may occur from a chamber corresponding to a center of the substrate frame to both chambers respectively corresponding to both side-ends of the substrate frame in this order.

The method may further include sequentially bringing the plurality of chambers into a positive pressure state using the pressure adjustment device so that the portions of the substrate frame respectively corresponding to a plurality of the chambers are sequentially separated from the suction plate.

The sequential bringing of the plurality of chambers into the positive pressure state may occur from a chamber corresponding to one side-end of the substrate frame to a chamber corresponding to the other side-end of the substrate frame in this order.

The sequential bringing of the plurality of chambers into the positive pressure state may occur from both chambers respectively corresponding to both side-ends of the substrate frame to a chamber corresponding to a center of the substrate frame in this order.

As mentioned above, the substrate frame suction apparatus according to one aspect of the invention may suction the substrate frame through the suction plate made of the porous material and hence may uniformly suction an entire surface of the substrate frame.

Moreover, the substrate frame suction apparatus may include the plural chambers defined in the body and thus may sequentially suction the substrate frame portion by portion using the pressure adjustment device. In this way, the substrate frame suction apparatus may reduce or prevent bending or twisting of the substrate frame that may otherwise occur in the process of suctioning the substrate frame.

### BRIEF DESCRIPTION OF THE DRAWINGS

Example embodiments will be more clearly understood from the following brief description taken in conjunction with the accompanying drawings. FIGS. 1-7 represent non-limiting, example embodiments described herein.

FIG. 1 is a perspective view of a substrate frame suction apparatus according to an embodiment;

FIG. 2 to FIG. 4 are side views illustrating operations of a substrate frame suction apparatus according to an embodiment; and

FIG. 5 to FIG. 7 are side views illustrating operations of a substrate frame suction apparatus according to another embodiment.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated list items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only sued to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Below, a substrate frame suction apparatus according to an embodiment will be described in detail with reference to the accompanying drawings.

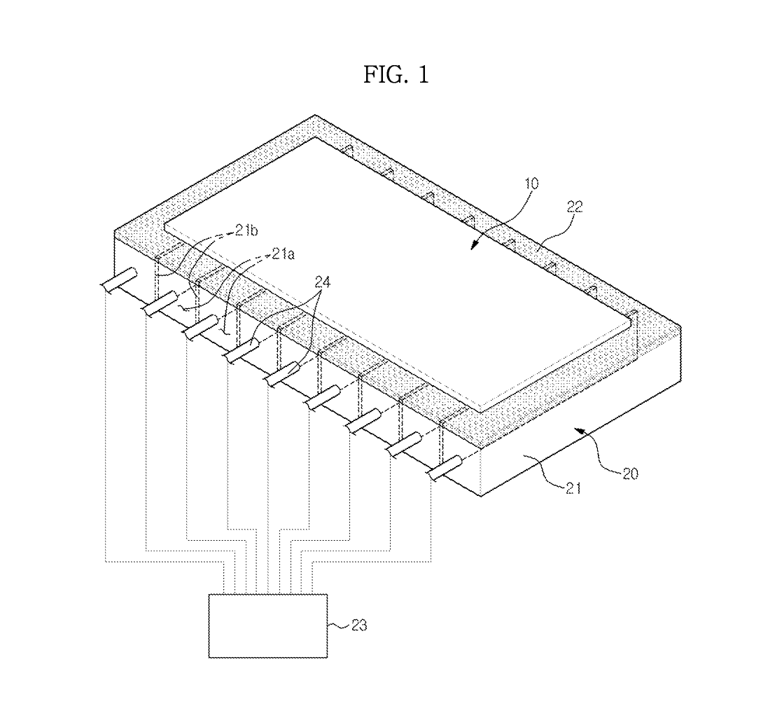

As shown in FIG. 1, a substrate frame suction apparatus 20 includes a body 21 having at least one top-side opened chamber 21a, a suction plate 22 to cover a top side(s) of the at least one chamber 21a and suction a substrate frame 10, and a pressure adjustment device 23 connected to the at least one chamber 21a through a connection pipe(s) 24 to adjust pressures in the at least one chamber 21a.

In this example embodiment, the suction plate 22 is made of a porous material having micro-pores as in a sponge and is configured to suction the substrate frame 10 in accordance with the pressures in the at least one chamber 21a. Specifically, when the pressure in the at least one chamber 21a becomes a negative pressure using the pressure adjustment device 23, a suction force is generated at the micro-pores of the suction plate 22 made of the porous material and thus the substrate frame 10 is suctioned to the suction plate 22. On the other hand, when the pressure in the at least one chamber 21a becomes a positive pressure using the pressure adjustment device 23, a suction force generated at the suction plate 22 disappears and thus the substrate frame 10 is separated from the suction plate 22. In an embodiment, the suction plate may be made of a silicon material having micro-pores therein.

Because the suction plate 22 is made of the porous material, the suction force is uniformly applied to an entire surface of the substrate frame 10 via the micro-pores formed in the suction plate 22. Thus, the suction force may be prevented from concentrating on a particular portion of the substrate frame 10 or the concentration of suction force on a particular portion of the substrate frame 10 may be reduced. As a result, bending of the suctioned substrate frame 10, may be suppressed, which may otherwise occur if the suction force concentrates at a particular portion of the substrate frame 10.

In this example embodiment, the at least one chamber 21a includes a plurality of chambers 21a defined in the body 21 using a plurality of partition walls 21b. The respective chambers 21a are individually connected to the pressure adjustment device 23 so that the pressure in each chamber 21a is independently controlled. Therefore, by individually adjusting the pressures in the respective chambers 21a using the pressure adjustment device 23, the suction force may be selectively applied only to portions of the suction plate 22 respectively corresponding to the plural chambers 21a.

By forming the suction plate 22 using the porous material and defining a plurality of the chambers 21a by the partition walls 21b, the suction force may be transferred, through the micro-pores formed in the suction plate 22, even to the portions of the suction plate 22 corresponding to the partition walls 21b. In this way, bending of the substrate frame 10 may be suppressed, which may otherwise occur when different suction forces are applied to different portions of the substrate frame respectively.

Hereinafter, a method of controlling the substrate frame suction apparatus as described above will be described in detail.

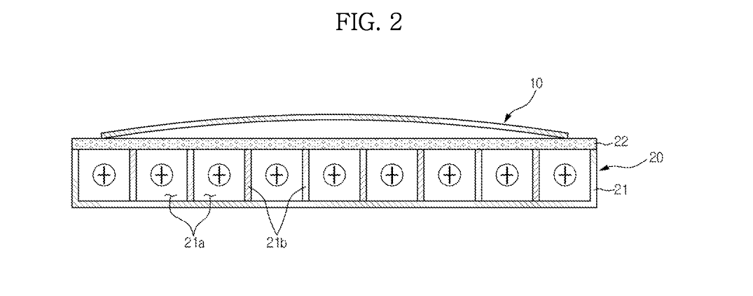

As shown in FIG. 2, while all of the chambers 21a are in a positive pressure state, the substrate frame 10 is placed on the suction plate 22. On the other hand, the substrate frame 10 may be partially or entirely bent by the heat or pressure applied in the course of mounting semiconductors on the substrate frame 10.

While the substrate frame 10 dwells on the suction plate 22, the pressure adjustment device 23 sequentially brings each of the chambers 21a into a negative pressure state by suctioning air from the chambers 21a. In this manner, by sequentially bringing each of the chambers 21a into the negative pressure state, the suction force may be generated only at the portions of the suction plate 22 corresponding to the respective chambers 21a and in turn the portions of the substrate frame 10 corresponding to the respective chambers 21a are sequentially suctioned to the suction plate 22.

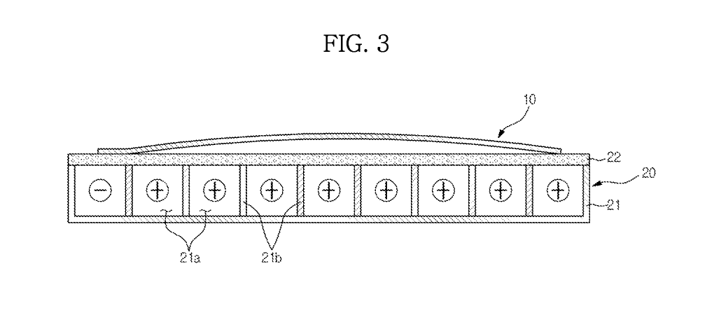

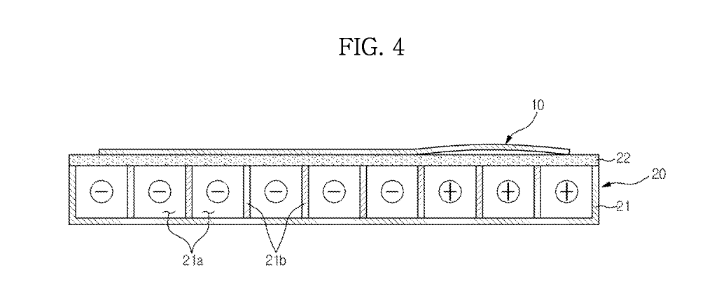

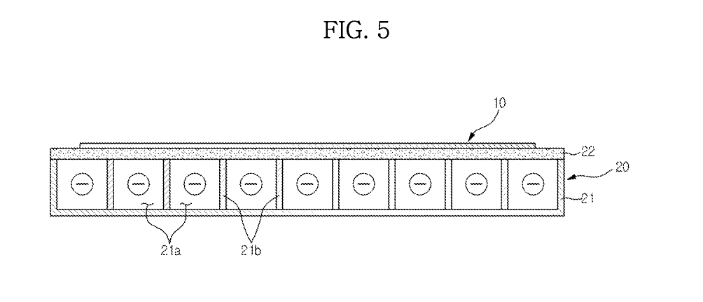

In this example embodiment, as shown in FIG. 3 to FIG. 5, the sequential bringing of each of the chambers 21a into the negative pressure state occurs from the chamber 21a corresponding to one side-end of the substrate frame 10 to the chamber 21a corresponding to the other side-end of the substrate frame 10 in this order. By this way of sequentially bringing each of the chambers 21a into the negative pressure state by controlling the pressure adjustment device 23, the substrate frame 10 may be partially and sequentially suctioned to the suction plate 22 from one side-end of the substrate frame 10 to the other side-end of the substrate frame 10.

By enabling the substrate frame 10 to be partially and sequentially suctioned to the suction plate 22 from one side-end of the frame 10 to the other side-end of the frame 10, the twisting or bending of the substrate frame 10 may be suppressed, which may otherwise occur in case when an entire surface of the substrate frame is suctioned to the suction plate at once.

After the substrate frame 10 has been suctioned to the suction plate 22, the substrate frame 10 and semiconductors disposed in the frame 10 begin to be tested using testers. Upon completion of the test process, each of the chambers 21a is sequentially brought into a positive pressure state using the pressure adjustment device 23. The sequential bringing of each of the chambers 21a into the positive pressure state occurs from a chamber 21a corresponding to one side-end of the substrate frame 10 to a chamber 21a corresponding to the other side-end of the substrate frame 10 in this order. In this way, the suction force is no longer generated at the suction plate 22 and hence the substrate frame 10 may be separated from the suction plate 22.

In this way, by sequentially bringing each of the chambers 21a into the positive pressure state, portions of the substrate frame 10 transformed during the suction process may be restored to original shapes thereof, thereby minimizing movement of the substrate frame 10.

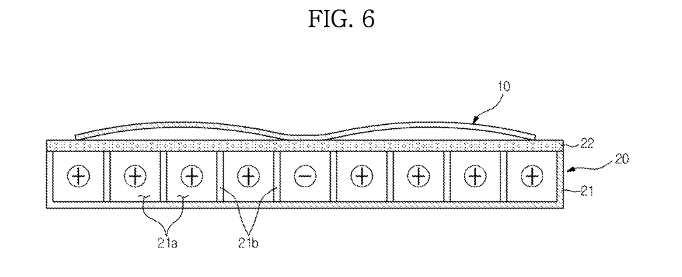

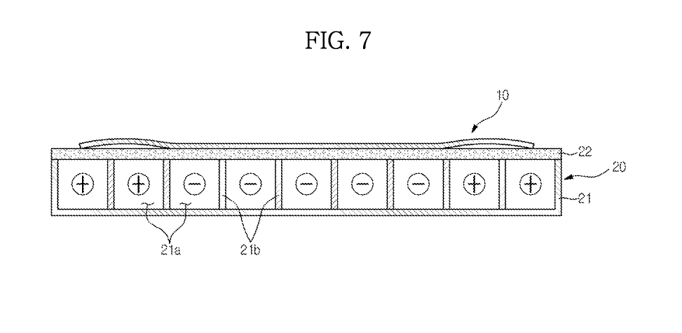

In the above example embodiment, the pressure adjustment device 23 is controlled such that the sequential bringing of each of the chambers 21a into the negative pressure state occurs from the chamber 21a corresponding to one side-end of the substrate frame 10 to the chamber 21a corresponding to the other side-end of the substrate frame 10 in this order. However, the invention is not limited thereto. Alternatively, as shown in FIG. 6 and FIG. 7, the pressure adjustment device 23 may be controlled in such a manner that the sequential bringing of each of the chambers 21a into the negative pressure state occurs from a chamber 21a corresponding to a center of the substrate frame 10 to both chambers 21a respectively corresponding to both side-ends of the substrate frame 10 in this order.

In this way, it is possible to sequentially bring the chambers 21a into the negative pressure state two by two using the pressure adjustment device 23. Thus, the substrate frame 10 may be more rapidly suctioned to the suction plate 22.

Upon completion of the test process on the substrate frame 10, the pressure adjustment device 23 is controlled such that the sequential bringing of each of the chambers 21a into the positive pressure state may occur from both chambers 21a respectively corresponding to both side-ends of the substrate frame 10 to a chamber 21a corresponding to a center of the substrate frame 10 in this order.

While example embodiments have been particularly shown and described, it will be understood by one of ordinary skill in the art that variations in form and detail may be made therein without departing from the spirit and scope of the claims.

What is claimed is:

1. A substrate frame suction apparatus comprising:
a body having at least one top-side opened chamber;
a suction plate made of a porous material to cover a top of the at least one chamber; and
a pressure adjustment device connected to the at least one chamber and configured to adjust a pressure in the at least one the chamber.

2. The apparatus according to claim 1, wherein the at least one chamber includes a plurality of chambers defined in the body using partition walls, and
the pressure adjustment device is connected to the respective chambers so as to achieve individual pressure adjustments of the plural chambers.

3. A method of controlling a substrate frame suction apparatus including a plurality of chambers, a suction plate and a pressure adjustment device to suction a substrate frame, the method comprising:
sequentially bringing each of the plurality of the chambers into a negative pressure state using the pressure adjustment device so that portions of the substrate frame respectively corresponding to the plurality of the chambers are sequentially suctioned to the suction plate.

4. The method according to claim 3, wherein the sequential bringing of the plurality of chambers into the negative pressure state occurs in order from a chamber corresponding to one side-end of the substrate frame to a chamber corresponding to the other side-end of the substrate frame.

5. The method according to claim 3, wherein the sequential bringing of the plurality of chambers into the negative pressure state occurs in order from a chamber corresponding to a center of the substrate frame to both chambers respectively corresponding to both side-ends of the substrate frame.

6. The method according to claim 3, further comprising:
sequentially bringing each of a plurality of the chambers into a positive pressure state using the pressure adjustment device so that the portions of the substrate frame respectively corresponding to the plurality of the chambers are sequentially separated from the suction plate.

7. The method according to claim 6, wherein the sequential bringing of each of the chambers into the positive pressure state occurs in order from a chamber corresponding to one side-end of the substrate frame to a chamber corresponding to the other side-end of the substrate frame.

8. The method according to claim 6, wherein the sequential bringing of each of the chambers into the positive pressure state occurs in order from both chambers respectively corresponding to both side-ends of the substrate frame to a chamber corresponding to a center of the substrate frame.
